(19) United States
(12) Patent Application Publication
(10) Pub. No.: US 2015/0346865 A1
(43) Pub. Date: Dec. 3, 2015

(54) TOUCH SCREEN PANEL

(71) Applicant: Electronics and Telecommunications Research Institute, Daejeon (KR)

(72) Inventors: Chan Hwa HONG, Gwangyang (KR); Woo-Seok CHEONG, Daejeon (KR)

(21) Appl. No.: 14/658,052

(22) Filed: Mar. 13, 2015

(30) Foreign Application Priority Data
Jun. 2, 2014 (KR) 10-2014-0066957

(51) Int. Cl. G06F 3/044

(52) U.S. Cl. CPC G06F 3/044

(57) ABSTRACT

A touch screen panel is provided. The panel includes a substrate including a cell area and a wiring area around the cell area; first electrode cells arranged in a first direction on the cell area of the substrate; second electrode cells on the cell area of the substrate, the second electrode cells disposed between the first electrode cells and arranged in a second direction intersecting the first direction; first connection electrodes on the cell area of the substrate, the first connection electrodes connecting the first electrode cells in the first direction; an insulating pattern covering the first connection electrodes and a portion of the second electrode cells adjacent to the first connection electrodes, the insulating pattern including contact holes exposing the second electrode cells; and second connection electrodes on the insulating patterns and connecting the adjacent second electrode cells in the second direction through the contact holes.

### CROSS-REFERENCE TO RELATED APPLICATIONS

This U.S. non-provisional patent application claims priority under 35 U.S.C. §119 of Korean Patent Application No. 10-2014-0066957, filed on Jun. 2, 2014, the entire contents of which are hereby incorporated by reference.

### BACKGROUND OF THE INVENTION

The present invention disclosed herein relates to a touch screen panel, and more particularly, to a window integrated touch screen panel including insulating patterns with contact holes.

Recently, as electronic devices such as computers and portable mobile communication terminals are becoming increasingly common, touch screens are extensively used as means for inputting data. The touch screens are classified into a resistive film type, a capacitive type, an ultrasonic type, and an infrared type. The capacitive type touch screen is promising in allowing multi touch (that is, the basis of a sensitivity touch) and manufacturing a high transmission sensor.

In the capacitive type touch screen, when a conductive material such as a finger touches a transparent electrode, a certain capacitance is generated at an insulating pattern. Thereby, a signal is generated at the touched point and the magnitude of the signal is calculated and its position is obtained. The insulating pattern used in the conventional capacitive type touch screen panel may have an island shape or a contact hole shape.

### SUMMARY OF THE INVENTION

The present invention provides a touch screen panel having improved reliability and transmittance.

Embodiments of the present invention provide touch screen panels comprising: a substrate including a cell area and a wiring area around the cell area; a plurality of first electrode cells arranged in a first direction on the cell area of the substrate; a plurality of second electrode cells on the cell area of the substrate, the second electrode cells disposed between the first electrode cells and arranged in a second direction intersecting the first direction; a plurality of first connection electrodes on the cell area of the substrate, the first connection electrodes connecting the first electrode cells in the first direction; an insulating pattern covering the first connection electrodes and a portion of the second electrode cells adjacent to the first connection electrodes, the insulating pattern including contact holes exposing the second electrode cells; and a plurality of second connection electrodes on the insulating patterns and connecting the adjacent second electrode cells in the second direction through the contact holes.

In other embodiments of the present invention, touch screen panels include: a substrate including a cell area and a wiring area around the cell area; a plurality of second connection electrodes on the cell area of the substrate; a plurality of insulating patterns covering the second connection electrodes, each of the insulating patterns including contact holes exposing both ends of the second connection electrodes; a plurality of first electrode cells on the cell area of the substrate between the insulating patterns and arranged in a first direction; a plurality of second electrode cells on the cell area of the substrate between the first electrode cells, arranged in a second direction intersecting the first direction, the second electrode cells contacting the second connection electrodes exposed by the contact holes to be connected to each other in the second direction; and a plurality of first connection electrodes on the insulating patterns, the first connection electrodes connecting the first electrode cells in the first direction, wherein the insulating patterns overlap a portion of the adjacent second electrode cells.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1A is a plan view of a touch screen panel according to an embodiment of the present invention;

FIG. 1B is a sectional view taken along a line I-I′ of FIG. 1A and FIG. 4;

FIG. 1C is an enlarged view of a portion C of FIG. 1A;

FIGS. 2A, 3A, and 4 are plan views illustrating a method of fabricating a touch screen panel according to an embodiment of the present invention;

FIGS. 2B and 3B are sectional views taken along a line I-I′ of FIG. 2A and FIG. 3A, respectively;

FIG. 5A is a plan view of a touch screen panel according to another embodiment of the present invention;

FIG. 5B is a sectional view taken along a line I-I′ of FIG. 5A;

FIG. 5C is an enlarged view of a portion D of FIG. 5A;

FIGS. 6A, 7A, and 8A are plan views illustrating a method of fabricating a touch screen panel according to another embodiment of the present invention;

FIGS. 6B, 7B and 8B are sectional views taken along a line I-I′ of FIG. 6A, 7A and FIG. 8A, respectively; and

FIG. 9 is a graph illustrating a simulation relating to changes in capacitance of a touch screen panel according to a width of insulating patterns.

### DETAILED DESCRIPTION OF PREFERRED EMBODIMENTS

The present invention will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. Like reference numerals refer to like elements throughout.

In the following description, the technical terms are used only for explaining specific embodiments while not limiting the present invention. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

Additionally, the embodiment in the detailed description will be described with sectional views as ideal exemplary views of the present invention. In the drawings, the dimensions of layers and regions are exaggerated for effective description of technical contents. In the figures, the dimensions of layers and regions are exaggerated for clarity of illustration. Therefore, the embodiments of the present invention are not limited to the specific shape illustrated in the exemplary views, but may include other shapes that may be created according to manufacturing processes. For example, an etched region illustrated as a rectangle may have rounded or curved features. Therefore, areas exemplified in the drawings have general properties and are used to illustrate a specific shape of a device area. Thus, this should not be construed as limited to the scope of the present invention.

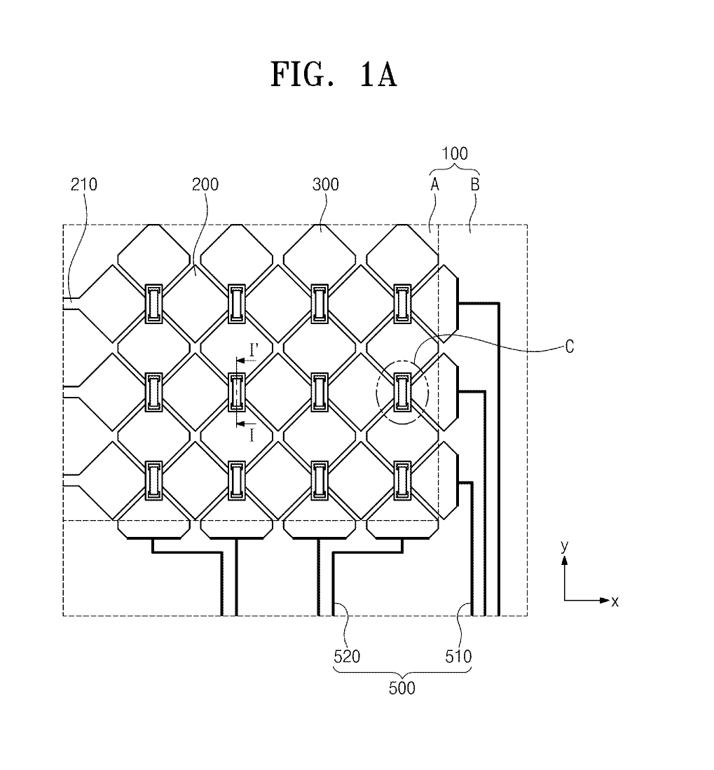

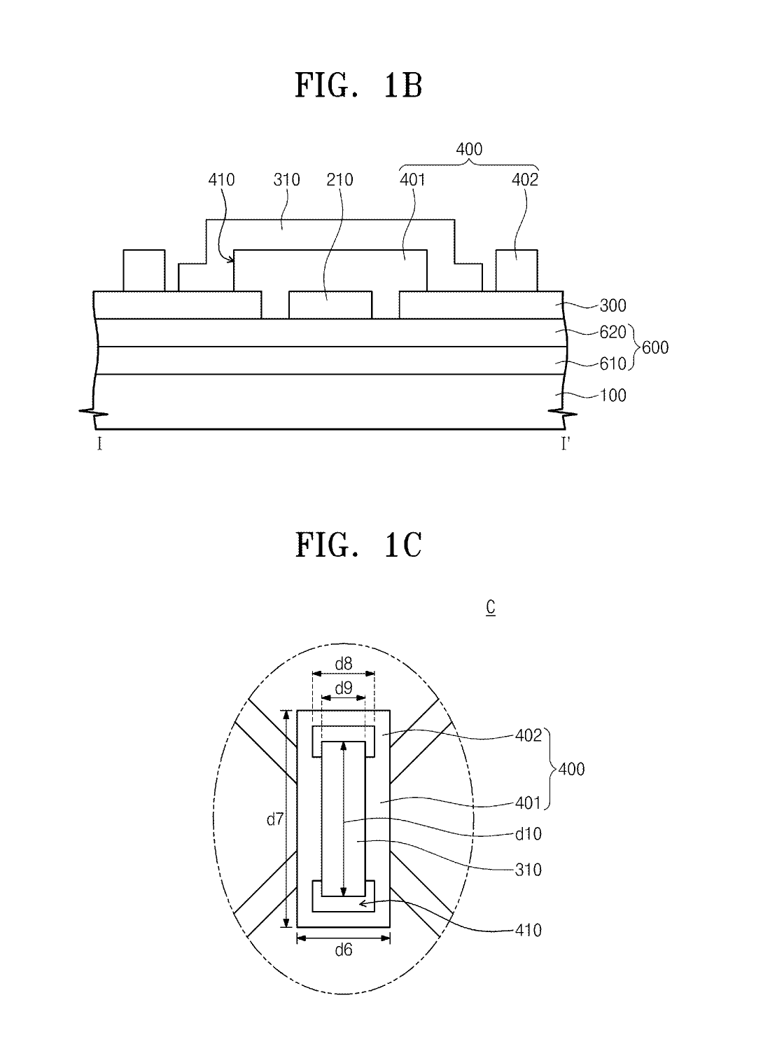

FIG. 1A is a plan view of a touch screen panel according to an embodiment of the present invention. FIG. 1B is a sectional view taken along a line I-I′ of FIG. 1A. FIG. 1C is an enlarged view of a portion C of FIG. 1A. Hereinafter, a touch screen panel according to an embodiment of the present invention will be described with reference to FIGS. 1A, 1B and 1C.

The touch screen panel includes a substrate 100, first electrode cells 200, first connection electrodes 210, second electrode cells 300, second connection electrodes 310, insulating patterns 400, metal wires 500, and a buffer layer 600.

The substrate 100 includes a cell area A and a wiring area B around the cell area A. The substrate 100 may be a tempered glass substrate, a reinforced plastic substrate, a polycarbonate (PC) substrate coated with a reinforced film, or a reinforced polyethylene terephthalate (PET) substrate.

The first electrode cells 200 may be arranged in a first direction on the cell area A of the substrate 100. The first direction may be an x-axis direction. As one example, the first electrode cells 200 may have a rhombic shape. The vertices of the rhombus adjacent in the first direction may be formed facing each other. The vertices of the rhombus adjacent in the second direction may be formed facing each other. The second direction may be a y-axis direction. However, this invention is not limited thereto and the first electrode cells 200 may be formed in a circular, oval, rectangular, square, or polygonal shape.

The first connection electrodes 210 may be arranged between the first electrode cells 200 on the cell area A and connect the first electrode cells 200 in the first direction. As one example, the vertices of the first electrode cells 200 adjacent to each other in the first direction may be connected by the first connection electrodes 210.

The second electrode cells 300 may be arranged in the second direction on the cell area A of the substrate 100 and may be formed between the first electrode cells 200. The second electrode cells 300 are separated from the first electrode cells 200, not to contact with the first electrode cells 200. As one example, the second electrode cells 300 may have an octagonal shape. The sides of the second electrode cells 300 may be formed facing each other. However, this invention is not limited thereto and the second electrode cells 300 may be formed in a circular, oval, rectangular, square, or polygonal shape.

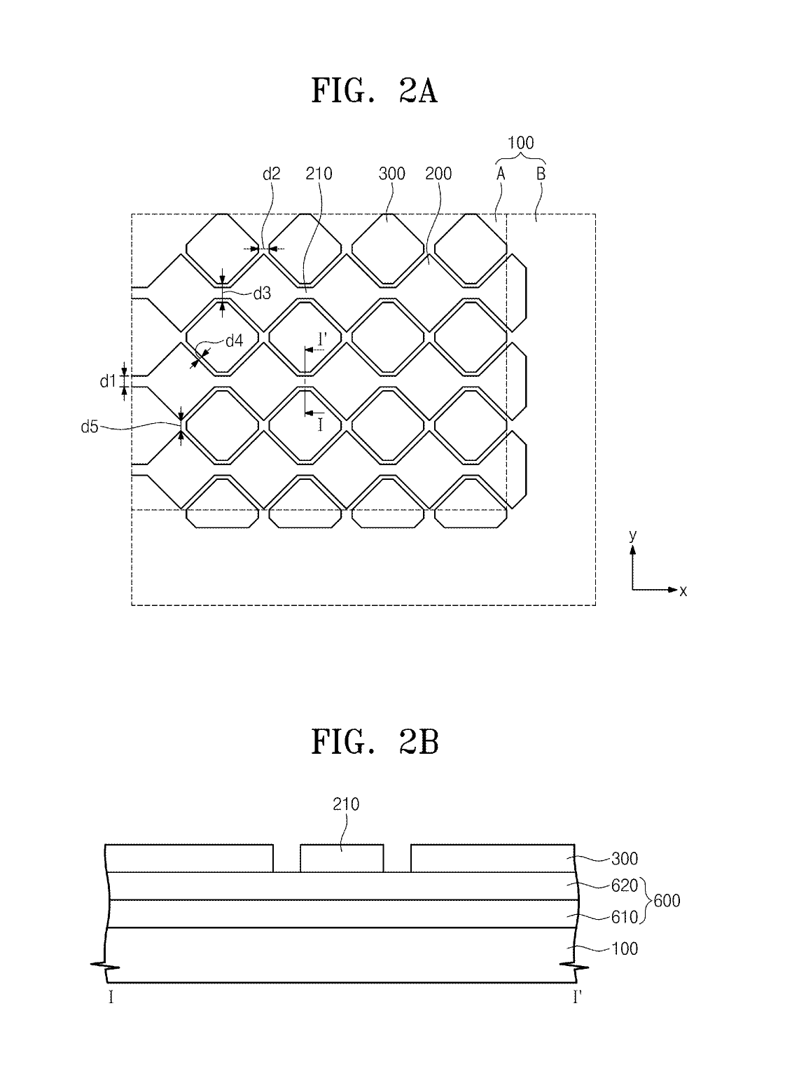

In one example, a width (reference numeral dl of FIG. 2A) of the first connection electrodes 210 and an interval (reference numeral d2 of FIG. 2A) between the second electrode cells 300 in the first direction may be about 20 μm to about 2000 μm. An interval (reference numeral d3 of FIG. 2A) between the second electrode cells 300 in the second direction may be broader than the width (reference numeral dl of FIG. 2A) of the first connection electrodes 210. A width (reference numeral d4 of FIG. 2A) between the first electrode cells 200 and the second electrode cells 300 adjacent to each other may be about 20 μm to about 2000 μm. An interval (reference numeral d5 of FIG. 2A) between the vertices of the first electrode cells 200 adjacent to each other in the second direction may be about 10 μm to about 1000 μm. The first electrode cells 200, the first connection electrodes 210, and the second electrode cells 300 may be formed of indium tin oxide (ITO).

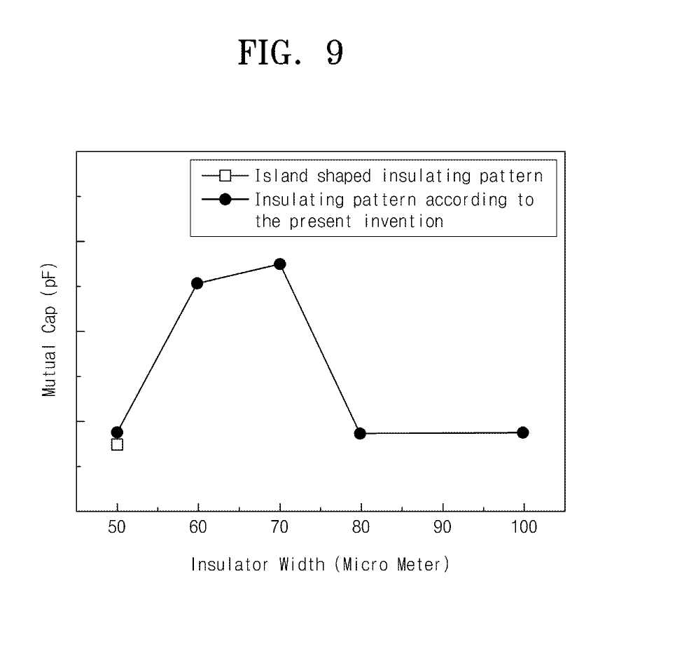

The insulating pattern 400 may cover the first connection electrodes 210 and a portion of the second electrode cells 300 adjacent to the first connection electrodes 210. The insulating pattern 400 may have contact holes 410 exposing the second electrode cells 300. The insulating pattern 400 may include an insulating body 401 insulating the first connection electrodes 210 from the second connection electrodes 310 and an insulating dam 402 around the contact hole 410. A width d6 and length d7 of the insulating pattern 400 may be about 1 μm to about 500 μm. The thickness of the insulating pattern 400 may be about 1 nm to about 10 μm. A capacitance value of the touch screen panel may vary according to the width d6 of the insulating pattern 400. When the width d6 of the insulating pattern 400 is about 50 μm to about 80 μm, the touch screen panel may have a high capacitance value (see FIG. 9). A width d8 of the contact hole 410 may be greater than or equal to a width d9 of the second connection electrodes 310 described later. As one example, the insulating pattern 400 may be formed of one of SiOx, SiNx, MgF₂, SiOxNy, or an organic insulator.

The second connection electrodes 310 are disposed on the insulating patterns 400 and may connect the adjacent second electrode cells 300 in the second direction through the contact hole 410. A length d10 of the second connection electrodes 310 may be shorter than the length d7 of the insulating pattern 400. The width d9 of the second connection electrodes 310 may be about 1 μm to about 100 μm. As one example, the second connection electrodes 310 may be formed of ITO or metal. According to embodiments of the present invention, the insulating dam 402 prevents the misalignment of the second connection electrodes 310, so that it may reduce a short-circuit occurring in a conventional island shaped insulating pattern due to the etching defect or position defect of the second connection electrodes. Additionally, since the insulating pattern 400 is small sufficiently, a refractive indexing matching issue and a thin film pollution issue occurring in a conventional contact hole shaped insulating pattern may be reduced.

Metal wires 500 may be formed to have a certain interval on the wiring area B of the substrate 100. The metal wires 500 may include a driving lines 510 connected to the first electrode cells 200 and a sensing lines 520 connected to the second electrode cells 300. An interval between the driving lines 510 and an interval between the sensing lines 520 may be about 20 μm to about 2000 μm. An interval between the driving lines 510 and an interval between the sensing lines 520 may be the same. A thickness of the metal wires 500 may vary according to a size of a touch screen panel and a resistance value of the metal wires 500. For example, the metal wires 500 may be formed of one of Mo, Al, Cu, Cr, Ag, Ti/Cu, Ti/Ag, Cr/Ag, Cr/Cu, Al/Cu, and Mo/Al/Mo. The second connection electrodes 310 and the metal wires 500 may be formed of the same material and in this case, the second connection electrodes 310 and the metal wires 500 may be formed at the same time.

Additionally, the buffer layer 600 may be formed between the substrate 100 and the first electrode cells 200, the first connection electrodes 210, and the second electrode cells 300. The buffer layer 600 may include a first buffer layer 610 and a second buffer layer 620. The first buffer layer 610 may be formed on the substrate 100. The first buffer layer 610 may have a thickness of about 2 nm to about 20 nm. The first buffer layer 610 is formed of an insulating material having a higher refractive index than that of the second buffer layer 620. The first buffer layer 610 may be a transparent insulating material having a refractive index of about 1.8 to about 2.9. As one example, the transparent insulating material may be one of TiO₂, Nb₂O₅, ZrO₂, Ta₂O₅, and HfO₂.

The second buffer layer 620 may be formed on the first buffer layer 610. The second buffer layer 620 may have a thickness of about 2 nm to about 20 nm. The second buffer layer 620 is formed of an insulating material having a lower refractive index than that of the first buffer layer 610. The second buffer layer 620 may be a transparent insulating material having a refractive index of about 1.3 to about 1.8. As one example, the transparent insulating material may be one of SiO₂, SiNx, MgF₂, and SiOxNy.

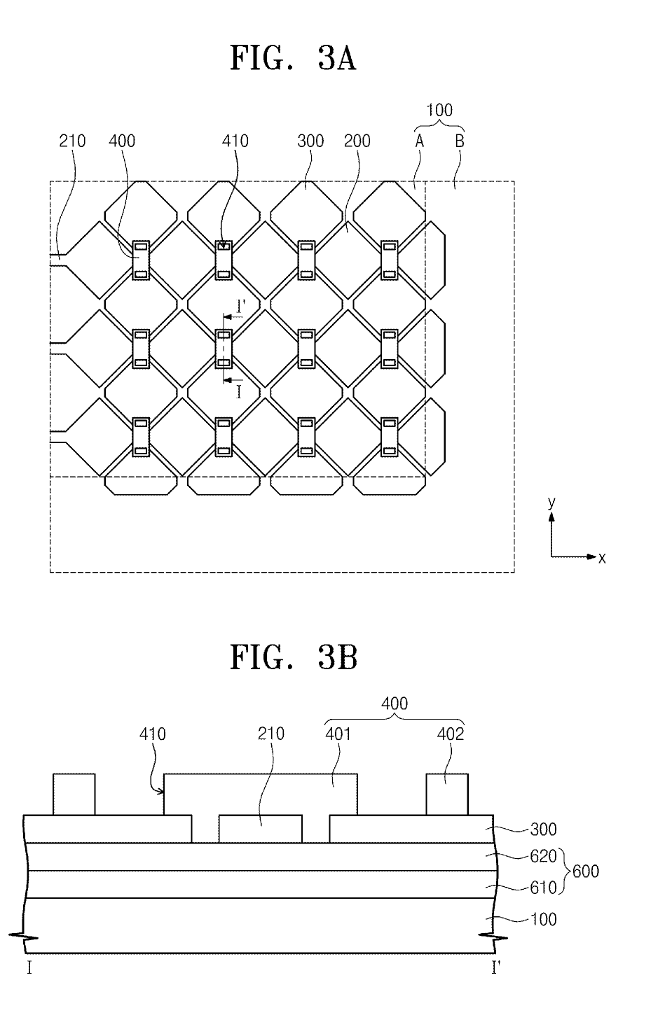

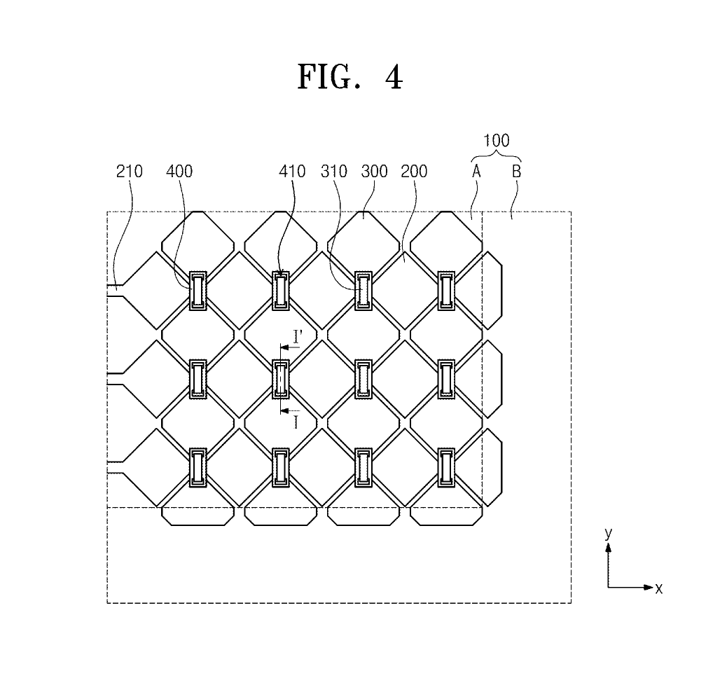

FIGS. 2A, 3A, and 4 are plan views illustrating a method of fabricating a touch screen panel according to an embodiment of this invention. FIG. 1B is a sectional view taken along a line I-I′ of FIG. 1A and FIG. 4. FIGS. 2B and 3B are sectional views taken along a line I-I′ of FIG. 2A and FIG. 3A, respectively. Hereinafter, a method of fabricating a touch screen panel according to an embodiment of this invention will be described with reference to FIGS. 2A, 2B, 3A, 3B and 4. Duplicated descriptions for a formation method and constituents of each component may be omitted.

Referring to FIGS. 2A and 2B, a substrate 100 including a cell area A and a wiring area B around the cell area A may be provided.

A buffer layer 600 may be formed on the substrate 100. The buffer layer 600 may include a first buffer layer 610 and a second buffer layer 620. The first buffer layer 610 may be formed on the substrate 100. The first buffer layer 610 may have a thickness of about 2 nm to about 20 nm. The first buffer layer 610 is formed of an insulating material having a higher refractive index than that of the second buffer layer 620. The first buffer layer 610 may be a transparent insulating material having a refractive index of about 1.8 to about 2.9. The first buffer layer 610 may be formed through one of a screen printing method, a physical vapor deposition method, a chemical vapor deposition method, or an atomic layer deposition method.

The second buffer layer 620 may be formed on the first buffer layer 610. The second buffer layer 620 may have a thickness of about 2 nm to about 20 nm. The second buffer layer 620 is formed of an insulating material having a lower refractive index than that of the first buffer layer 610. The second buffer layer 620 may be a transparent insulating material having a refractive index of about 1.3 to about 1.8. The second buffer layer 620 may be formed through one of a screen printing method, a physical vapor deposition method, a chemical vapor deposition method, or an atomic layer deposition method.

A plurality of first electrode cells 200 arranged in a first direction may be formed on the buffer layer 600 of the cell area A. The first direction may be an x-axis direction. In one example, the first electrode cells 200 may have a rhombic shape. The vertices of the rhombus adjacent in the first direction may be formed facing each other. The vertices of the rhombus adjacent in the second direction may be formed facing each other. The second direction may be a y-axis direction. However, this invention is not limited thereto and the first electrode cells 200 may be formed in a circular, oval, rectangular, square, or polygonal shape.

A plurality of second electrode cells 300 disposed between the first electrode cells 200 and arranged in the second direction may be formed on the buffer layer 600 of the cell area A. In one example, the second electrode cells 300 may have an octagonal shape. The sides of the second electrode cells 300 may be formed facing each other. However, this invention is not limited thereto and the second electrode cells 300 may be formed in a circular, oval, rectangular, square, or polygonal shape.

A plurality of first connection electrodes 210 connecting the first electrode cells 200 in the first direction may be formed on the buffer layer 600 of the cell area A. As one example, the vertices of the first electrode cells 200 adjacent to each other in the first direction may be connected by the first connection electrodes 210.

In one example, the width dl of the first connection electrodes 210 and the interval d2 in the first direction between the second electrode cells 300 may be about 20 μm to about 2000 μm. The interval d3 in the second direction between the second electrode cells 300 may be broader than the width dl of the first connection electrodes 210. The width d4 between the first electrode cells 200 and the second electrode cells 300 adjacent to each other may be about 20 μm to about 2000 μm. The interval d5 between the vertices of the first electrode cells 200 adjacent to each other in the second direction may be about 10 μm to about 1000 μm.

The first electrode cells 200, the first connection electrodes 210, and the second electrode cells 300 may be formed at the same time by forming a transparent conductive layer (not shown) on the buffer layer 600 and patterning the transparent conductive layer. As one example, the transparent conductive layer may be formed of ITO. The transparent conductive layer may be formed through one of a screen printing method, a physical vapor deposition method, a chemical vapor deposition method, or an atomic layer deposition method. The transparent conductive layer may be patterned through a photoresist process, a wet etching process, or a dry etching process.

Referring to FIGS. 3A and 3B, an insulating pattern 400 may be formed to cover the first connection electrodes 210 and a portion of the second electrode cells 300 adjacent to the first connection electrodes 210. The insulating pattern 400 may have contact holes exposing the second electrode cells 300. The width (reference numeral d6 of FIG. 1C) and length (reference numeral d7 of 1C) of the insulating pattern 400 may be about 1 μm to about 500 μm. The thickness of the insulating pattern 400 may be about 1 nm to about 10 μm. A width (reference numeral d8 of FIG. 1C) of the contact hole 410 may be greater than or equal to a width (reference numeral d9 of FIG. 1C) of the second connection electrodes 310 described later. The insulating pattern 400 may be formed by forming an insulating layer (not shown) on the buffer layer 600 where the first electrode cells 200, the first connection electrodes 210, and the second electrode cells 300 are formed, and patterning the insulating layer. The insulating layer may be formed through one of a screen printing method, a physical vapor deposition method, a chemical vapor deposition method, or an atomic layer deposition method. The insulating layer may be patterned through a photoresist process, a wet etching process, or a dry etching process.

Referring to FIGS. 4 and 1B, a plurality of second connection electrodes 310 may be formed on the insulating patterns 400 to connect the adjacent second electrode cells in the second direction through the contact hole 410. The length (reference numeral d10 of FIG. 1C) of the second connection electrodes 310 may be shorter than the length (reference numeral d7 of FIG. 1C) of the insulating pattern 400. The width (reference numeral d9 of FIG. 1C) of the second connection electrodes 310 may be about 1 μm to about 100 μm. The second connection electrodes 310 may be formed by forming a conductive layer (not shown) on the buffer layer 600 where the first electrode cells 200, the first connection electrodes 210, and the second electrode cells 300 are formed and patterning the conductive layer. As one example, the conductive layer may be formed of ITO or metal. The conductive layer may be formed through one of a screen printing method, a physical vapor deposition method, a chemical vapor deposition method, or an atomic layer deposition method. The conductive layer may be patterned through a photoresist process, a wet etching process, or a dry etching process.

Referring again to FIG. 1A, after the forming of the second connection electrodes 310, metal wires 500 may be formed on the buffer layer 600 of the wiring area B. The metal wires 500 may include a driving lines 510 connected to the first electrode cells 200 and a sensing lines 520 connected to the second electrode cells 300. An interval between the driving lines 510 and an interval between the sensing lines 520 may be about 20 μm to about 2000 μm. An interval between the driving lines 510 and an interval between the sensing lines 520 may be the same. A thickness of the metal wires 500 may vary according to a size of a touch screen panel and a resistance value of the metal wires 500. The metal wires 500 may be formed by forming a conductive layer (not shown) on the buffer layer 600 of the wiring area B and patterning the conductive layer. As one example, the conductive layer may be formed of one of Mo, Al, Cu, Cr, Ag, Ti/Cu, Ti/Ag, Cr/Ag, Cr/Cu, Al/Cu, and Mo/Al/Mo. The conductive layer may be formed through one of a screen printing method, a physical vapor deposition method, a chemical vapor deposition method, or an atomic layer deposition method. The conductive layer may be patterned through a photoresist process, a wet etching process, or a dry etching process.

According to another embodiment of this invention, the second connection electrodes 310 and the metal wires 500 may be formed of the same material and in this case, the second connection electrodes 310 and the metal wires 500 may be formed at the same time.

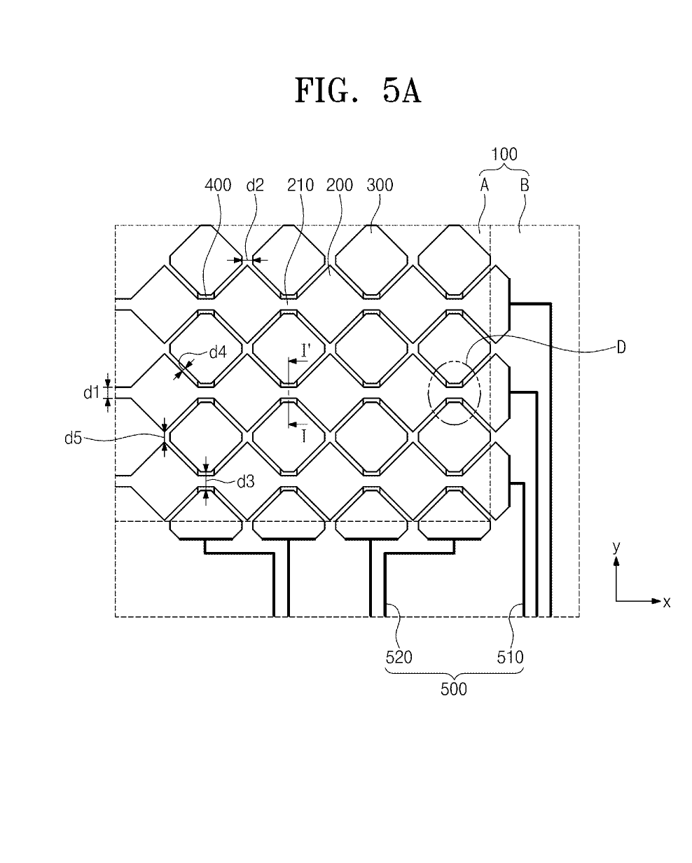

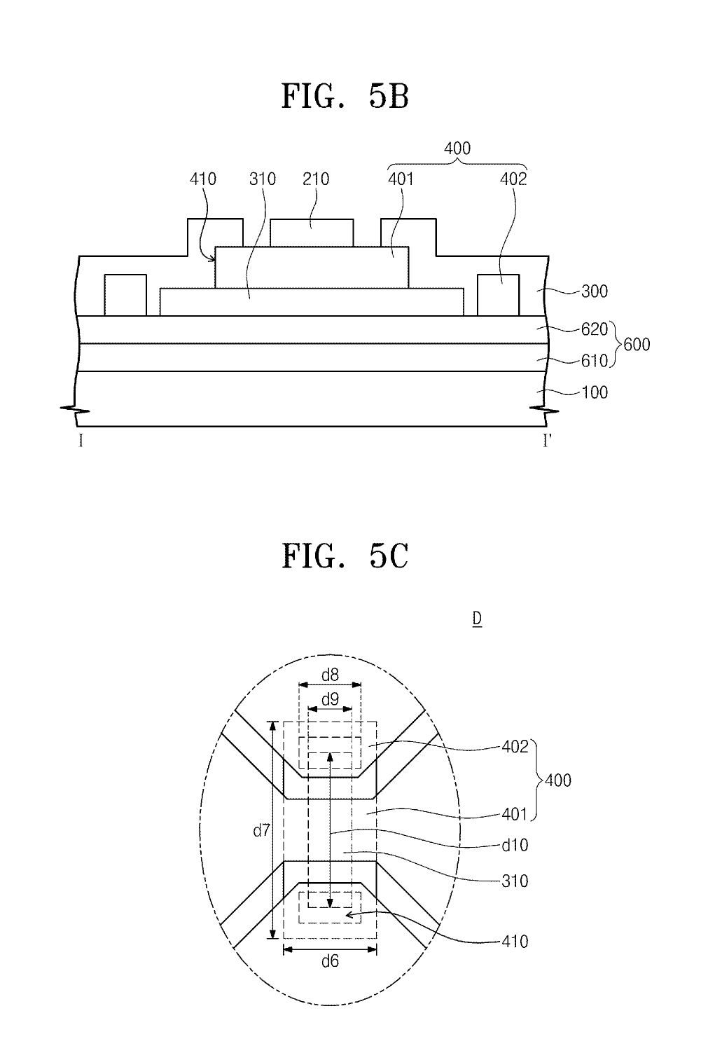

FIG. 5A is a plan view of a touch screen panel according to another embodiment of this invention. FIG. 5B is a sectional view taken along a line I-I′ of FIG. 5A. FIG. 5C is an enlarged view of a portion D of FIG. 5A. Hereinafter, a touch screen panel according to another embodiment of this invention will be described with reference to FIGS. 5A to 5C.

The touch screen panel may include a substrate 100, first electrode cells 200, first connection electrodes 210, second electrode cells 300, second connection electrodes 310, insulating patterns 400, metal wires 500, and a buffer layer 600.

The substrate 100 includes a cell area A and a wiring area B around the cell area A. The substrate 100 may be a tempered glass substrate, a reinforced plastic substrate, a polycarbonate (PC) substrate coated with a reinforced film, or a reinforced polyethylene terephthalate (PET) substrate.

The second connection electrodes 310 may be arranged on the substrate 100 of the cell area A in a regular interval. The second connection electrodes 310 may be arranged in a regular interval in a first direction and a second direction. The first direction may be an x-axis direction and the second direction may be a y-axis direction. A length d10 of the second connection electrodes 310 may be shorter than a length d7 of the insulating pattern 400. A width d9 of the second connection electrodes 310 may be about 1 μm to about 100 μm. As one example, the second connection electrodes 310 may be formed of ITO or metal.

The insulating pattern 400 may cover a portion of the second connection electrodes 310 and may include contact holes 410 exposing the both ends of the second connection electrodes 310. The insulating pattern 400 may include an insulating body 401 insulating the first connection electrodes 210 from the second connection electrodes 310 and an insulating dam 402 around the contact hole 410. A width d6 and length d7 of the insulating pattern 400 may be about 1 μm to about 500 μm. The thickness of the insulating pattern 400 may be about 1 nm to about 10 μm. A width d8 of the contact hole 410 may be greater than or equal to a width d9 of the second connection electrodes 310. A length d7 of the insulating pattern 400 may be longer than a length d10 of the second connection electrodes 310. As one example, the insulating pattern 400 may be formed of one of SiOx, SiNx, MgF₂, SiOxNy, or an organic insulator. Even when some misalignments occur between the first connection electrodes 210 and the second connection electrodes 310, the insulating pattern 400 may insulate them each other. Even if particles occur when the second connection electrodes 310 are patterned, an insulating dam 402 may reduce a short circuit between the first electrode cells 200 and the second electrode cells 300. Additionally, since the insulating pattern 400 is small sufficiently, a refractive indexing matching issue and a thin film pollution issue occurring in a conventional contact hole shaped insulating layer may be reduced.

The first electrode cells 200 may be disposed on the substrate 100 of the cell area A, between the insulating patterns 400. The first electrode cells 200 may be disposed in a first direction. The first direction may be an x-axis direction. In one example, the first electrode cells 200 may have a rhombic shape. The vertices of the rhombus adjacent in the first direction may be formed facing each other. The vertices of the rhombus adjacent in the second direction may be formed facing each other. The second direction may be a y-axis direction. However, this invention is not limited thereto and the first electrode cells 200 may be formed in a circular, oval, rectangular, square, or polygonal shape.

The first connection electrodes 210 may be disposed on the insulating pattern 400 to connect the first electrode cells 200 in the first direction. In one example, the vertices of the first electrode cells 200 adjacent to each other in the first direction may be connected by the first connection electrodes 210.

The second electrode cells 300 may be disposed on the substrate 100 of the cell area A between the first electrode cells 200 and may be arranged in the second direction. The second electrode cells 300 may be connected in the second direction by the second connection electrodes 310 exposed by the contact hole 410. The insulating pattern 400 and the second electrode cells 300 adjacent thereto may overlap each other only at a portion. As one example, the second electrode cells 300 may have an octagonal shape. The sides of the second electrode cells 300 may be formed facing each other. However, this invention is not limited thereto and the second electrode cells 300 may be formed in a circular, oval, rectangular, square, or polygonal shape.

As one example, the width dl of the first connection electrodes 210 and the interval d2 in the first direction between the second electrode cells 300 may be about 20 μm to about 2000 μm. The interval d3 in the second direction between the second electrode cells 300 may be broader than the width dl of the first connection electrodes 210. The width d4 between the first electrode cells 200 and the second electrode cells 300 adjacent to each other may be about 20 μm to about 2000 μm. The interval d5 between the vertices of the first electrode cells 200 adjacent to each other in the second direction may be about 10 μm to about 1000 μm. The first electrode cells 200, the first connection electrodes 210, and the second electrode cells 300 may be formed of ITO.

Metal wires 500 may be formed to have a certain interval on the substrate 100 of the wiring area B. The metal wires 500 may include a driving lines 510 connected to the first electrode cells 200 and a sensing lines 520 connected to the second electrode cells 300. An interval between the driving lines 510 and an interval between the sensing lines 520 may be about 20 μm to about 2000 μm. An interval between the driving lines 510 and an interval between the sensing lines 520 may be the same. A thickness of the metal wires 500 may vary according to a size of a touch screen panel and a resistance value of the metal wires 500. As one example, the metal wires 500 may be formed of one of Mo, Al, Cu, Cr, Ag, Ti/Cu, Ti/Ag, Cr/Ag, Cr/Cu, Al/Cu, and Mo/Al/Mo. The second connection electrodes 310 and the metal wires 500 may be formed of the same material and in this case, the second connection electrodes 310 and the metal wires 500 may be formed at the same time.

Additionally, the buffer layer 600 may be formed between the substrate 100 and the first electrode cells 200, the second electrode cells 300, and the second connection electrodes 310. The buffer layer 600 includes a first buffer layer 610 and a second buffer layer 620.

The first buffer layer 610 may be formed on the substrate 100. The first buffer layer 610 may have a thickness of about 2 nm to about 20 nm. The first buffer layer 610 is formed of an insulating material having a higher refractive index than that of the second buffer layer 620. The first buffer layer 610 may be a transparent insulating material having a refractive index of about 1.8 to about 2.9. In one example, the transparent insulating material may be one of TiO₂, Nb₂O₅, ZrO₂, Ta₂O₅, and HfO₂.

The second buffer layer 620 may be formed on the first buffer layer 610. The second buffer layer 620 may have a thickness of about 2 nm to about 20 nm. The second buffer layer 620 is formed of an insulating material having a lower refractive index than that of the first buffer layer 610. The second buffer layer 620 may be a transparent insulating material having a refractive index of about 1.3 to about 1.8. As one example, the transparent insulating material may be one of SiO₂, SiNx, MgF₂, and SiOxNy.

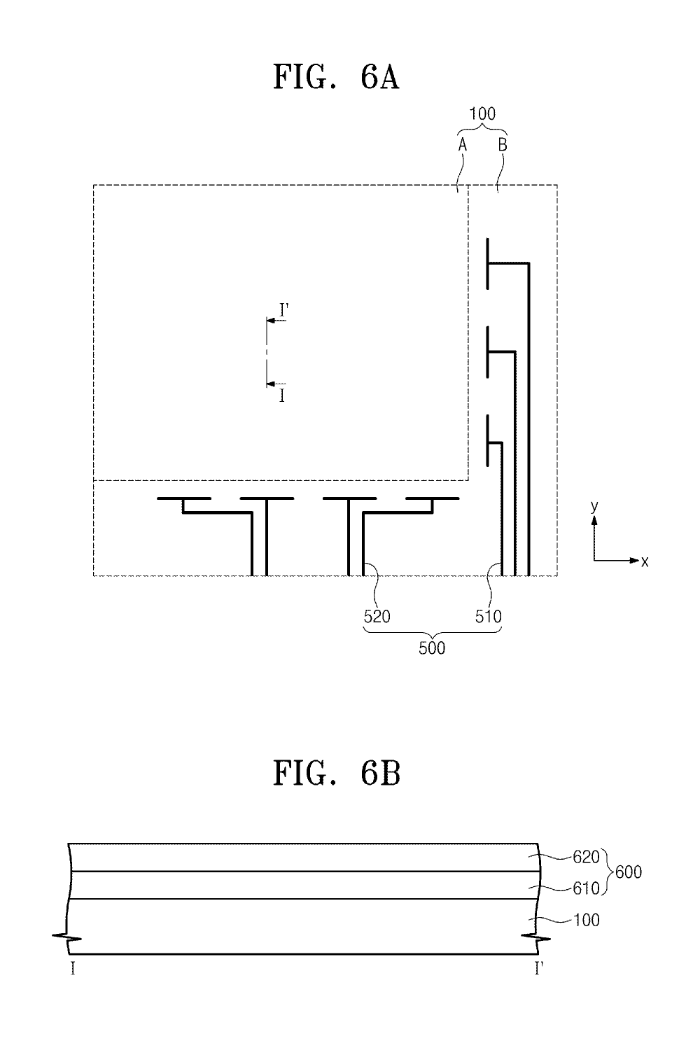

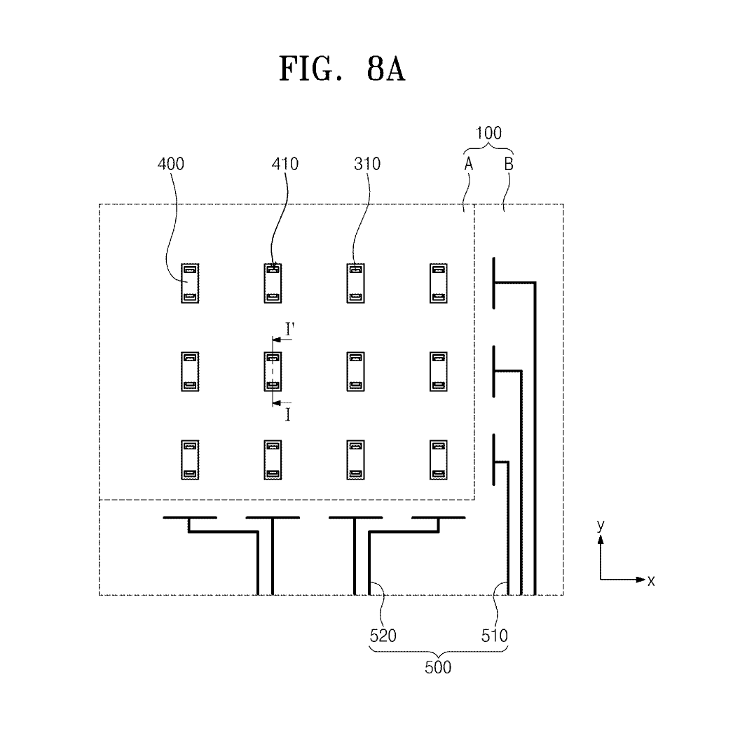

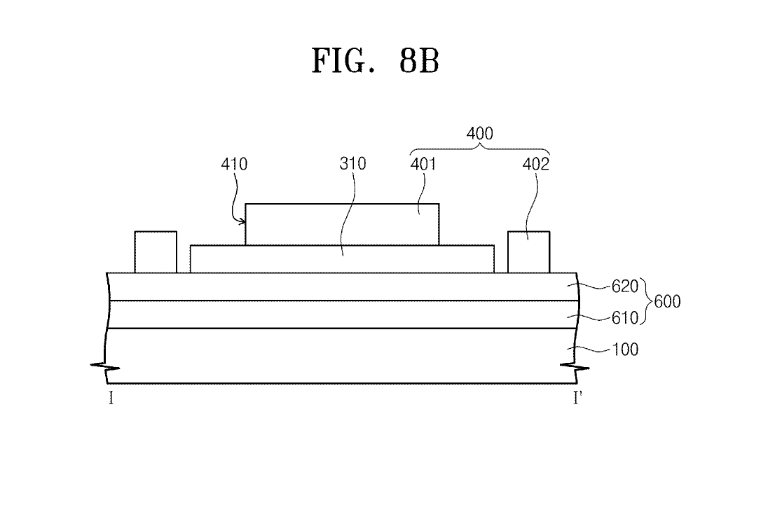

FIGS. 6A, 7A and 8A are plan views illustrating a method of fabricating a touch screen panel according to another embodiment of this invention. FIGS. 6B, 7B and 8B are sectional views taken along a line I-I′ of FIG. 6A, 7A and FIG. 8A, respectively. Hereinafter, a method of fabricating a touch screen panel according to another embodiment of this invention will be described with reference to FIGS. 6A, 6B, 7A, 7B, 8A and 8B. Duplicated descriptions for a formation method and constituents of each component may be omitted.

Referring to FIGS. 6A and 6B, a substrate 100 including a cell area A and a wiring area B around the cell area A may be provided.

A buffer layer 600 may be formed on the substrate 100. The buffer layer 600 may include a first buffer layer 610 and a second buffer layer 620. The substrate 100 may be a tempered glass substrate, a reinforced plastic substrate, a polycarbonate (PC) substrate coated with a reinforced film, or a reinforced polyethylene terephthalate (PET) substrate.

The first buffer layer 610 may be formed on the substrate 100. The first buffer layer 610 may have a thickness of about 2 nm to about 20 nm. The first buffer layer 610 is formed of an insulating material having a higher refractive index than that of the second buffer layer 620. The first buffer layer 610 may be a transparent insulating material having a refractive index of about 1.8 to about 2.9.

The second buffer layer 620 may be formed on the first buffer layer 610. The second buffer layer 620 may have a thickness of about 2 nm to about 20 nm. The second buffer layer 620 is formed of an insulating material having a lower refractive index than that of the first buffer layer 610. The second buffer layer 620 may be a transparent insulating material having a refractive index of about 1.3 to about 1.8.

Metal wires 500 may be formed on the second buffer layer 620 of the wiring area B. The metal wires 500 may include a driving lines 510 connected to the first electrode cells 200, which are described later, and a sensing lines 520 connected to the second electrode cells 300, which are described later. An interval between the driving lines 510 and an interval between the sensing lines 520 may be about 20 μm to about 2000 μm. An interval between the driving lines 510 and an interval between the sensing lines 520 may be the same. A thickness of the metal wires 500 may vary according to a size of a touch screen panel and a resistance value of the metal wires 500. The Metal wires 500 may be formed by forming a conductive layer (not shown) on the wiring area B of the buffer layer 600 and patterning the conductive layer.

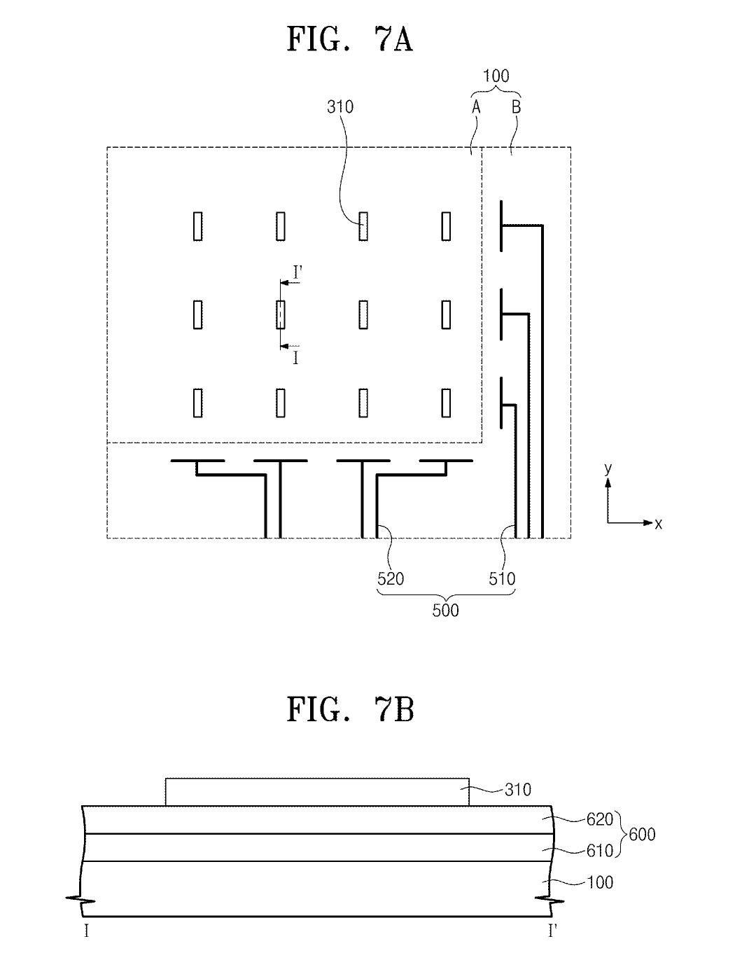

Referring to FIGS. 7A and 7B, after the forming of the metal wires 500, a plurality of second connection electrodes 310 may be formed on the buffer layer 600 of the cell area A in a regular interval. The second connection electrodes 310 may be arranged in a regular interval in a first direction and a second direction. The first direction may be an x-axis direction and the second direction may be a y-axis direction. The width (see d9 of FIG. 5C) of the second connection electrodes 310 may be about 1 μm to about 100 μm. The second connection electrodes 310 may be formed by forming a conductive layer (not shown) on the buffer layer 600 and patterning the conductive layer.

According to another embodiment of this invention, the second connection electrodes 310 and the metal wires 500 may be formed of the same material and in this case, the second connection electrodes 310 and the metal wires 500 may be formed at the same time.

Referring to FIGS. 8A and 8B, an insulating pattern 400 may be formed on the second connection electrodes 310. The insulating pattern 400 may include contact holes 410 exposing the both ends of the second connection electrode 310. The width (see d6 of FIG. 5C) and length (see d7 of FIG. 5C) of the insulating pattern 400 may be about 1 μm to about 500 μm. The thickness of the insulating pattern 400 may be about 1 nm to about 10 μm. A width (see d8 of FIG. 5C) of the contact hole 410 may be greater than or equal to a width (see d9 of FIG. 5C) of the second connection electrodes 310. A length (see d7 of FIG. 5C) of the insulating pattern 400 may be longer than a length (see d10 of FIG. 5C) of the second connection electrodes 310. The insulating pattern 400 may be formed by forming an insulating layer (not shown) on the buffer layer 600 including the second connection electrodes 310 and patterning the insulating layer.

Referring again to FIGS. 5A, 5B and 5C, a plurality of first electrode cells 200 disposed between a plurality of the insulating patterns 400 and arranged in the first direction may be formed on the substrate 100 of the cell area A. As one example, the first electrode cells 200 may have a rhombic shape. The vertices of the rhombus adjacent in the first direction may be formed facing each other. The vertices of the rhombus adjacent in the second direction may be formed facing each other. The second direction may be a y-axis direction. However, this invention is not limited thereto and the first electrode cells 200 may be formed in a circular, oval, rectangular, square, or polygonal shape.

A plurality of second electrode cells 300 disposed between the first electrode cells 200, arranged in the second direction, and connected in the second direction by the second connection electrodes 310 may be formed on the substrate 100 of the cell area A. The insulating pattern 400 and the second electrode cells 300 adjacent thereto may overlap each other only at a portion. As one example, the second electrode cells 300 may have an octagonal shape. The sides of the second electrode cells 300 may be formed facing each other. However, this invention is not limited thereto and the second electrode cells 300 may be formed in a circular, oval, rectangular, square, or polygonal shape.

A plurality of first connection electrodes 210 connecting the first electrode cells 200 in the first direction may be formed on the insulating pattern 400. As one example, the vertices of the first electrode cells 200 adjacent to each other in the first direction may be connected. The first electrode cells 200, the first connection electrodes 210, and the second electrode cells 300 may be formed at the same time by forming a transparent conductive layer (not shown) on the buffer layer 600 where the second connection electrodes 310 and the insulating patterns 400 are formed and patterning the transparent conductive layer.

FIG. 9 is a graph illustrating a simulation relating to changes in capacitance of a touch screen panel according to a width of the insulating pattern. Referring to FIG. 9, it is confirmed that a capacitance value of a touch screen panel changes according a width of the insulating pattern 400. Additionally, when a width of the insulating pattern 400 is about 50 μm to about 80 μm, it is confirmed that the touch screen panel has a high capacitance value. As a capacitance value becomes higher, the intensity of an electric field occurring between the first electrode cells 200 and the second electrode cells 300 may become stronger and as a result, the sensitivity of a touch panel may be improved.

According to a touch screen panel of this invention, the size of the insulating pattern may be several μm to several hundreds of μm, so that the touch screen panel may have high transmittance.

According to a touch screen panel of this invention, by selecting an appropriate width of the insulating pattern, the maximum capacitance value may be obtained.

According to a touch screen panel of this invention, a short circuit due to pattern errors of second connection electrodes or etching defects may be reduced.

According to a touch screen panel of this invention, when second connection electrodes are formed of metal, the second connection electrodes and metal wires may be formed at the same time, so that this may contribute to process simplification and drop of production costs.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A touch screen panel comprising:
a substrate including a cell area and a wiring area around the cell area;
a plurality of first electrode cells arranged in a first direction on the cell area of the substrate;
a plurality of second electrode cells on the cell area of the substrate, the second electrode cells disposed between the first electrode cells and arranged in a second direction intersecting the first direction;
a plurality of first connection electrodes on the cell area of the substrate, the first connection electrodes connecting the first electrode cells in the first direction;
an insulating pattern covering the first connection electrodes and a portion of the second electrode cells adjacent to the first connection electrodes, the insulating pattern including contact holes exposing the second electrode cells; and
a plurality of second connection electrodes on the insulating pattern and connecting the adjacent second electrode cells in the second direction through the contact hole.

2. The panel of claim 1, further comprising metal wires on the wiring area of the substrate, the metal wires connected to the first electrode cells and the second electrode cells.

3. The panel of claim 2, wherein the second connection electrodes are formed of the same material as the metal wires.

4. The panel of claim 1, further comprising a buffer layer between the substrate and the first electrode cells, the first connection electrodes, and the second electrode cells.

5. The panel of claim 4, wherein the buffer layer has a structure in which a first buffer layer and a second buffer layer having a lower refractive index than the first buffer layer are sequentially stacked.

6. The panel of claim 1, wherein a width of the contact hole in the first direction is greater than or equal to a width of the second connection electrodes in the first direction.

7. The panel of claim 1, wherein a length of the second connection electrodes in the second direction is shorter than a length of the insulating pattern in the second direction.

8. The panel of claim 1, wherein a width of the insulating pattern in the first direction is about 50 μm to about 80 μm.

9. The panel of claim 1, wherein the insulating pattern is formed of one selected from SiOx, SiNx, MgF₂, SiOxNy, and an organic insulating layer.

10. A touch screen panel comprising:
a substrate including a cell area and a wiring area around the cell area;
a plurality of second connection electrodes on the cell area of the substrate;
a plurality of insulating patterns covering the second connection electrodes, each of the insulating patterns including contact holes exposing both ends of the second connection electrodes;
a plurality of first electrode cells on the cell area of the substrate between the insulating patterns and arranged in a first direction;
a plurality of second electrode cells on the cell area of the substrate between the first electrode cells, arranged in a second direction intersecting the first direction, the second electrode cells contacting the second connection electrodes exposed by the contact holes to be connected to each other in the second direction; and
a plurality of first connection electrodes on the insulating patterns, the first connection electrodes connecting the first electrode cells in the first direction,
wherein the insulating patterns overlap a portion of the adjacent second electrode cells.

11. The panel of claim 10, further comprising metal wires on the wiring area of the substrate, the metal wires connected to the first electrode cells and the second electrode cells.

12. The panel of claim 11, wherein the second connection electrodes are formed of the same material as the metal wires.

13. The panel of claim 10, further comprising a buffer layer between the substrate and the first electrode cells, the second electrode cells, and the second connection electrodes.

14. The panel of claim 13, wherein the buffer layer has a structure in which a first buffer layer and a second buffer layer having a lower refractive index than the first buffer layer are sequentially stacked.

15. The panel of claim 10, wherein a width of the contact holes in the first direction is greater than or equal to a width of the second connection electrodes in the first direction.

16. The panel of claim 10, wherein a length of the second connection electrodes in the second direction is shorter than a length of the insulating patterns in the second direction.

17. The panel of claim 10, wherein a width of the insulating patterns in the first direction is about 50 μm to about 80 μm.

18. The panel of claim 10, wherein the insulating patterns are formed of one selected from SiOx, SiNx, MgF₂, SiOxNy, and an organic insulating layer.
